(19) United States
(12) Patent Application Publication
(10) Pub. No.: US 2021/0183338 A1
(43) Pub. Date: Jun. 17, 2021

(54) DEFORMABLE ELECTRONIC DEVICE, FOLDABLE DISPLAY DEVICE AND METHOD OF CONTROLLING THE SAME

(71) Applicant: InnoLux Corporation, Miao-Li County (TW)

(72) Inventors: Yuan-Lin Wu, Miao-Li County (TW); CHANDRA LIUS, Miao-Li County (TW)

(21) Appl. No.: 17/184,604

(22) Filed: Feb. 25, 2021

Related U.S. Application Data
(63) Continuation of application No. 16/049,789, filed on Jul. 30, 2018.

(51) Int. Cl. G09G 5/14; G06F 1/16

(52) U.S. Cl. CPC G09G 5/14; G09G 2380/02; G09G 2320/0686; G06F 1/1652

(57) ABSTRACT

A method of controlling a foldable display device including a flexible substrate and a display layer, having a foldable display portion connecting a first display portion and a second display portion of the display layer, includes providing a first predetermined angle, sensing a folding angle between the first display portion and the second display portion of the display layer, comparing the folding angle with the first predetermined angle, providing a first display status of the foldable display device when the folding angle is less than the first predetermined angle, and providing a second display status of the foldable display device when the folding angle is equal to or greater than the first predetermined angle, wherein the first display status is a turn-off status, and the second display status is a turn-on status, and the flexible substrate has a plurality of openings.

### CROSS REFERENCE TO RELATED APPLICATIONS

This application is a continuation application of U.S. application Ser. No. 16/049,789, filed on Jul. 30, 2018, the content of which is hereby incorporated by reference in their entirety.

### BACKGROUND OF THE DISCLOSURE

### 1. Field of the Disclosure

The present disclosure relates to a method of controlling a foldable display device, and more particularly, to a deformable electronic device.

### 2. Description of the Prior Art

In recent years, foldable or deformable electronic devices have become one of the focuses of the new generation electronic technology. The demand of the foldable display device that can be integrated in the electronic device is therefore increased. A foldable display device means the device can be curved, folded, stretched, flexed, rollable, or the like. Since foldable/deformable electronic device may have variable display areas in accordance with its deformable display region, the manufactures need to develop suitable controlling method of the foldable/deformable electronic device in order to improve the function and performance of the electronic device.

### SUMMARY OF THE DISCLOSURE

In some embodiments, a method of controlling a foldable display device is provided. The foldable display device includes a flexible substrate and a display layer disposed on the flexible substrate. The display layer includes a first display portion, a second display portion, and a foldable display portion connecting the first display portion and the second display portion. The method includes providing a first predetermined angle, sensing a folding angle between the first display portion and the second display portion, comparing the folding angle with the first predetermined angle, providing a first display status of the foldable display device when the folding angle is less than the first predetermined angle, and providing a second display status of the foldable display device when the folding angle is equal to or greater than the first predetermined angle.

In some embodiments, a method of controlling a deformable electronic device is provided. The deformable electronic device includes a deformable substrate and a display layer disposed on the deformable substrate. The method includes providing a first predetermined deformation datum, sensing a deformation value of the deformable electronic device, comparing the deformation value with the first predetermined deformation datum, providing a first display status of the deformable electronic device when the deformation value is less than the first predetermined deformation datum, and providing a second display status of the deformable electronic device when the deformation value is equal to or greater than the first predetermined deformation datum.

In some embodiments, a deformable electronic device is provided. The deformable electronic device includes a deformable substrate, an electronic layer disposed on the deformable substrate, a memory unit configured to store a first predetermined deformation datum, a bending sensor unit configured to sense a deformation value of the deformable electronic device, and a processing unit. The processing unit is configured to compare the deformation value with the first predetermined deformation datum, to provide a first operating status of the deformable electronic device when the deformation value is less than the first predetermined deformation datum, and to provide a second operating status of the deformable electronic device when the deformation value is equal to or greater than the first predetermined deformation datum.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a top-view schematic diagram of an electronic device according to a first embodiment of the present disclosure.

FIG. 2 is a side-view schematic diagram illustrating the folding appearance of the electronic device according to the first embodiment of the present disclosure.

FIG. 3 is a partial enlargement of a top-view of the electronic device shown in FIG. 1.

FIG. 4 is a sectional schematic diagram of the electronic device shown in FIG. 3 along line A-A′.

FIG. 5 is a partial enlargement of a top-view of an electronic device according to a variant embodiment of the first embodiment of the present disclosure.

FIG. 6 is a sectional schematic diagram of the electronic device shown in FIG. 5 along line B-B′.

FIG. 7 is a flow chart illustrating the method of controlling the electronic device shown in FIG. 1.

FIG. 8 is a schematic diagram showing the appearance of different display statuses of the electronic device shown in FIG. 1.

FIG. 9 is a flow chart showing a method of controlling the electronic device according to a second embodiment of the present disclosure.

FIG. 10 is a schematic diagram illustrating the appearance of the electronic device in different display statuses.

FIG. 11 is a schematic diagram illustrating the appearance of an electronic device according to a variant embodiment of the second embodiment of the present disclosure.

FIG. 12 is a flow chart showing a method of controlling an electronic device according to a third embodiment of the present disclosure.

FIG. 13 is a schematic diagram illustrating the appearance of the electronic device in different display statuses.

FIG. 14 is a flow chart showing a method of controlling an electronic device according to a forth embodiment of the present disclosure.

FIG. 15 is a flow chart showing a method of controlling an electronic device according to a fifth embodiment of the present disclosure.

FIG. 16 is a flow chart showing a method of controlling an electronic device according to a sixth embodiment of the present disclosure.

FIG. 17 is a schematic top-view of the deformable substrate of the electronic device of the sixth embodiment of the present disclosure.

FIG. 18 is a schematic diagram illustrating the appearances of the electronic device in different display statuses of the sixth embodiment of the present disclosure.

FIG. 19 is a schematic diagram illustrating the appearances of an electronic device in different display statuses according to a seventh embodiment of the present disclosure.

FIG. 20 is a flow chart showing the method of controlling an electronic device according to an eighth embodiment of the present disclosure.

FIG. 21 is a schematic diagram illustrating the appearances of the electronic device in different display statuses of the eighth embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the display device, and certain elements in various drawings may not be drawn to scale. In addition, the number and dimension of each device shown in drawings are only illustrative and are not intended to limit the scope of the present disclosure.

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include”, “comprise” and “have” are used in an open-ended fashion, and thus should be interpreted to mean “include, but not limited to . . . ”.

It will be understood that when an element or layer is referred to as being “on” or “connected to” another element or layer, it can be directly on or directly connected to the other element or layer, or intervening elements or layers may be presented. In contrast, when an element is referred to as being “directly on” or “directly connected to” another element or layer, there are no intervening elements or layers presented.

It should be noted that the technical features in different embodiments described in the following can be replaced, recombined, or mixed with one another to constitute another embodiment without departing from the spirit of the present disclosure.

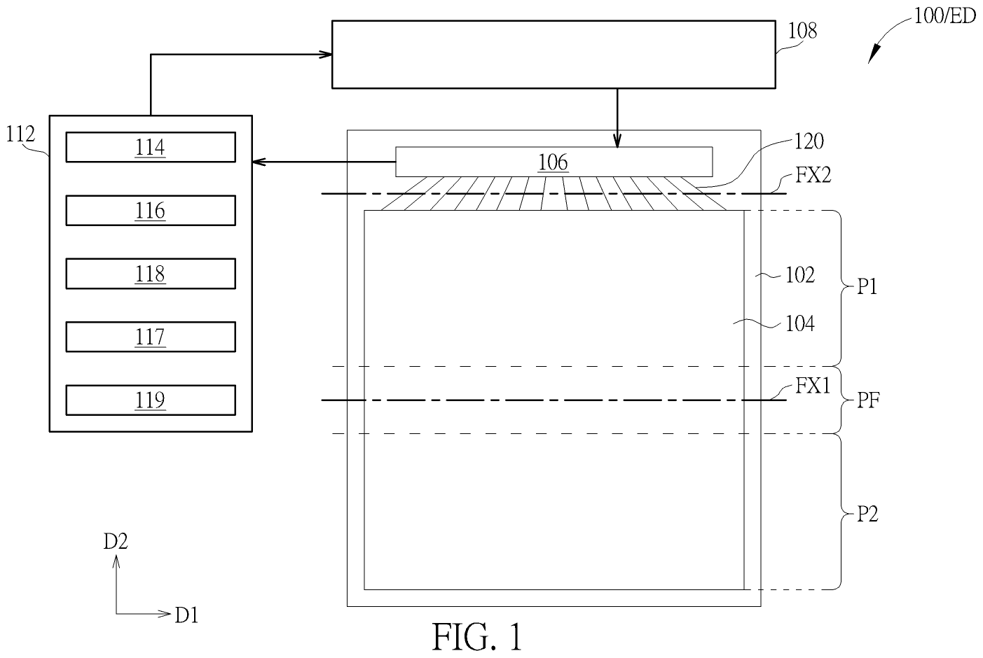

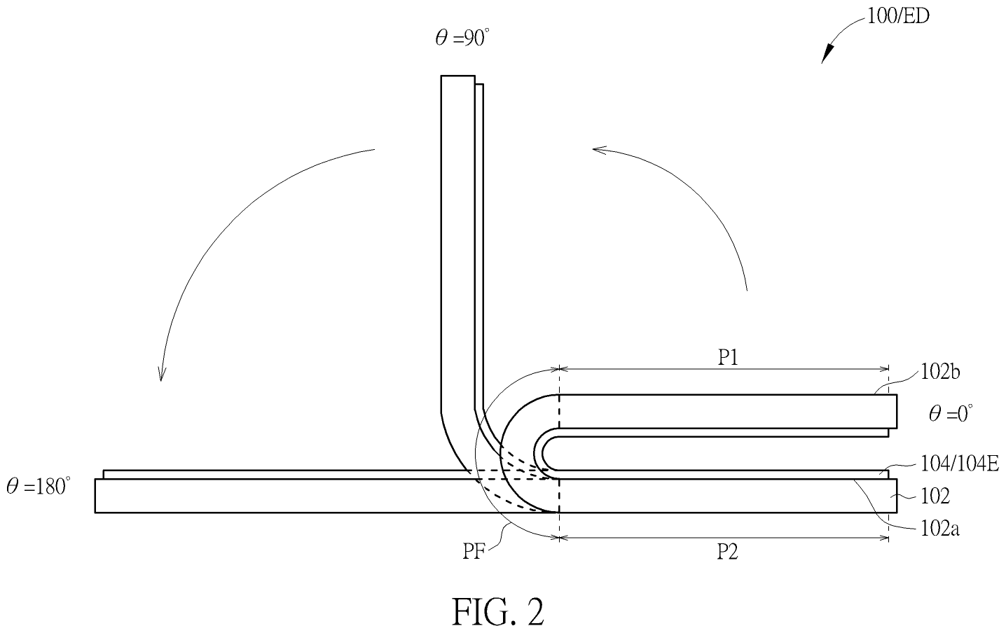

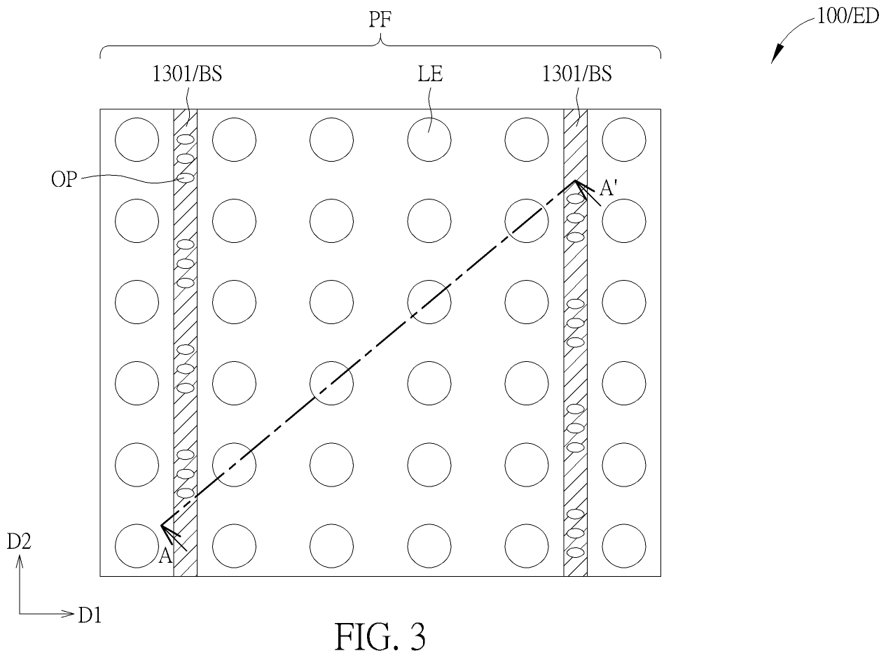

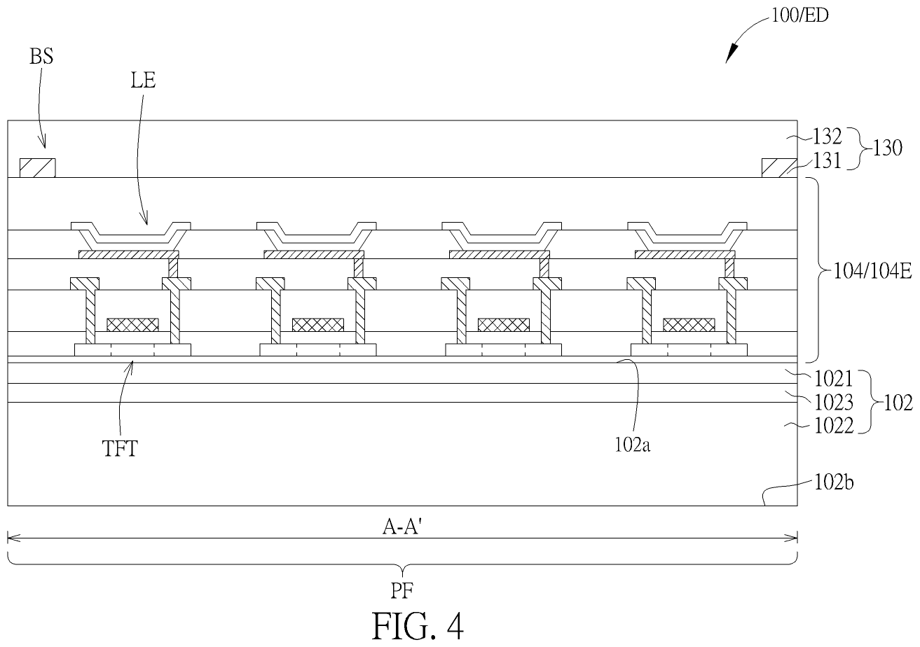

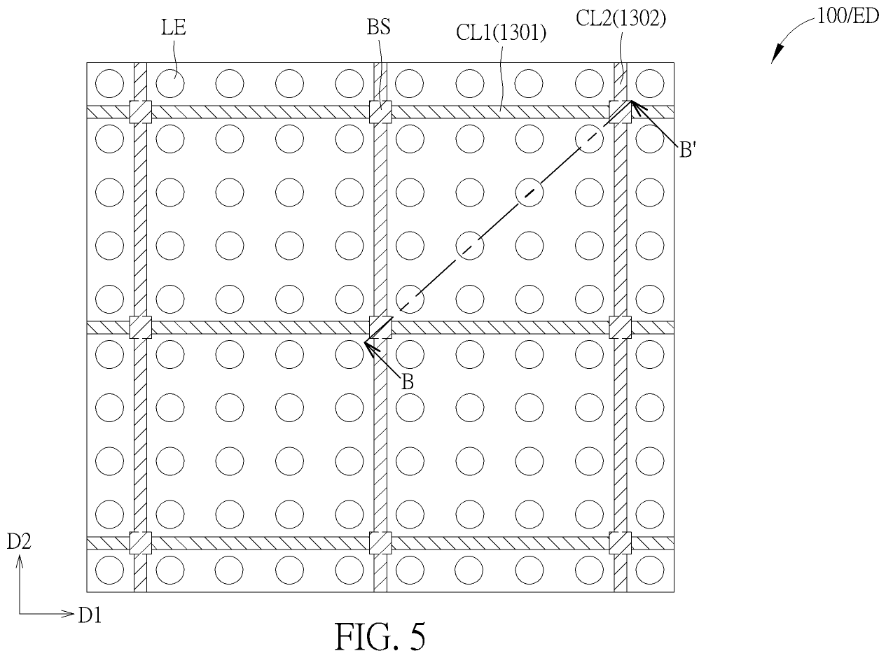

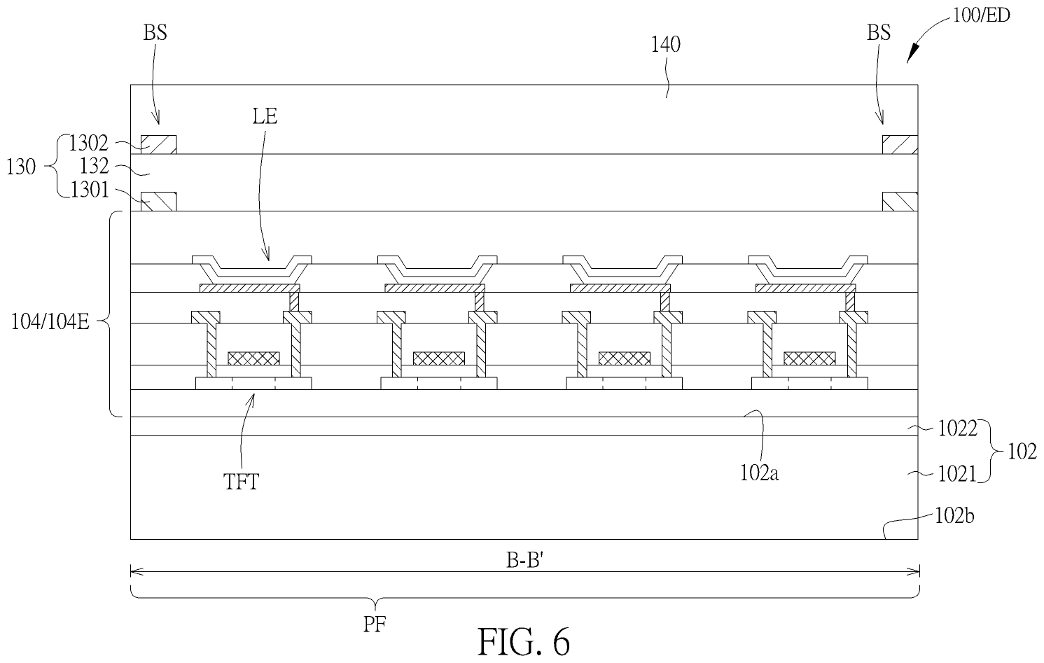

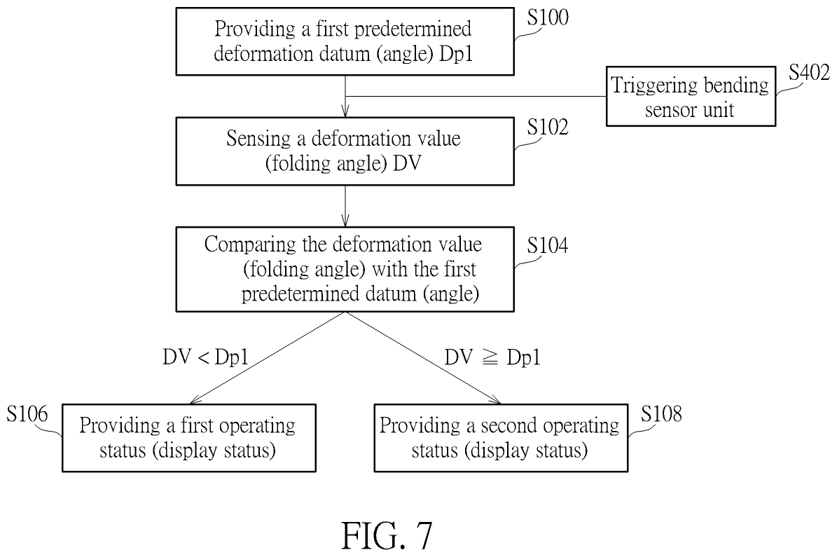

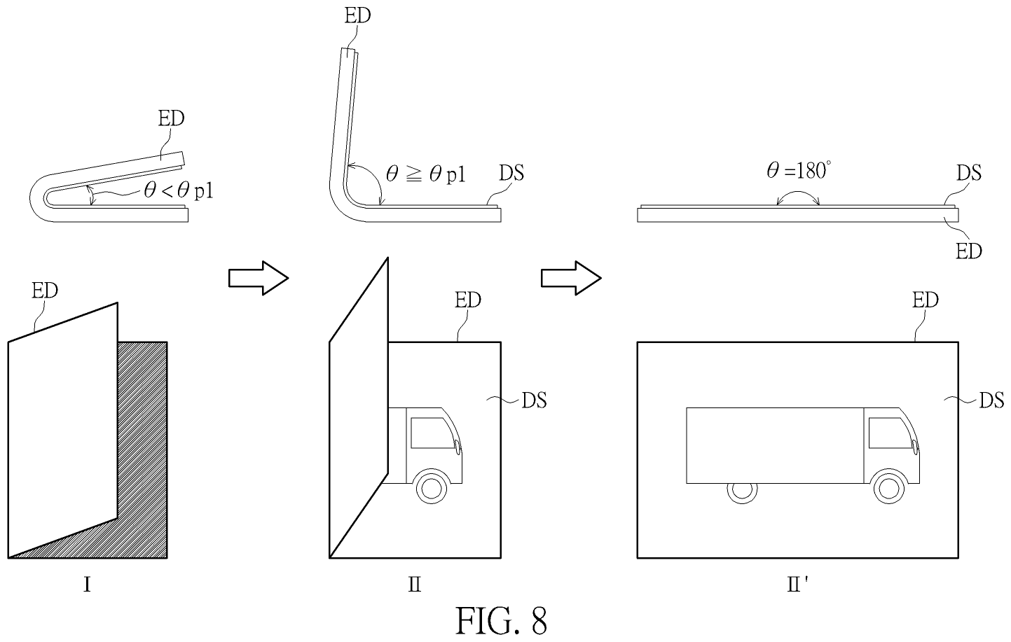

Referring to FIG. 1 to FIG. 8, FIG. 1 is a top-view schematic diagram of a deformable electronic device according to a first embodiment of the present disclosure, FIG. 2 is a side-view schematic diagram illustrating the folding appearance of the deformable electronic device according to the first embodiment of the present disclosure, FIG. 3 is a partial enlargement of a top-view of the electronic device shown in FIG. 1, FIG. 4 is a sectional schematic diagram of the electronic device shown in FIG. 3 along line A-A′, FIG. 5 is a partial enlargement of a top-view of an electronic device according to a variant embodiment of the first embodiment of the present disclosure, FIG. 6 is a sectional schematic diagram of the electronic device shown in FIG. 5 along line B-B′, FIG. 7 is a flow chart illustrating the method of controlling the electronic device shown in FIG. 1, and FIG. 8 is a schematic diagram showing the appearance of different display statuses of the electronic device shown in FIG. 1. As shown in FIG. 1 and FIG. 2, the electronic device ED of the first embodiment of the present disclosure is a deformable electronic device. As an example, the deformable electronic device ED may include a deformable display device that could display images. The term “deformable” means that at least a part of the electronic device ED/deformable display device could be deformed, curved, bended, folded, stretched, flexed, and/or rolled. For example, a portion of the electronic device ED may be curved, bended, folded, stretched, flexed, and/or rolled along a specific direction, but not limited thereto. In this embodiment, the deformable display device may be a foldable display device 100 for explanation the present disclosure.

The deformable electronic device of the present disclosure can include a deformable substrate, and an electronic layer disposed on the deformable substrate. According to some embodiments, the electronic layer can include a display layer and can display images. According to some embodiments, the electronic layer can have no display function; for example, can include an antenna, such as a liquid crystal antenna.

For easy explanation, an example is taken when the electronic layer is a display layer, and the deformable electronic device can be foldable. Thus, the deformable electronic device ED is a foldable display device 100, as shown in FIG. 1. The foldable display device 100 can be folded along at least one folding axis, for example, along the folding axis FX1 of a first direction D1.

In this embodiment, the deformable electronic device ED (the foldable display device 100) includes a deformable substrate 102 and a display layer 104 disposed on a first surface 102a of the deformable substrate 102, wherein the display layer 104 represents the electronic layer mentioned above. The deformable substrate 102 maybe a foldable substrate or a flexible substrate and may have a first folding axis FX1, and the display layer 104 may include a foldable display portion PF. The foldable display portion PF may be curved, bended, folded, stretched, flexed, and/or rolled along the first folding axis FX1. The first folding axis FX1 may be in parallel to a first direction D1 shown in FIG. 1. The display layer 104 may also include a first display portion P1 and a second display portion P2, and the foldable display portion PF is connected between the first display portion P1 and the second display portion P2 . In this embodiment, the foldable display portion PF is positioned and connected between the first display portion P1 and the second display portion P2 in a second direction D2. The second direction D2 may be perpendicular to the first direction D1, but not limited thereto.

As mentioned above, according to some embodiments, the electronic layer can have no display function; for example, can include a medium layer and a circuit layer. The medium layer can be a liquid crystal layer, the circuit layer can be formed by a thin film process, and can include TFTs, and thus the deformable electronic device ED can be a deformable antenna, such as a liquid crystal antenna. In addition, similar to the display layer 104, an electronic layer 104E can be disposed on a first surface 102a of the deformable substrate 102. The electronic layer 104E may include a foldable portion (as marked by “PF” in FIG. 1), which may be folded along the first folding axis FX1. The first folding axis FX1 may be in parallel to a first direction D1 shown in FIG. 1. The electronic layer 104E may also include a first portion (marked by P1) and a second portion (marked by P2), and the foldable portion PF is connected between the first portion P1 and the second portion P2. In this embodiment, the foldable portion PF is positioned and connected between the first portion P1 and the second portion P2 in a second direction D2. The second direction D2 may be perpendicular to the first direction D1, but not limited thereto.

According to a first embodiment, as shown in FIG. 2, the deformable electronic device ED can be a foldable display device 100, and the deformable substrate 102 can be a flexible substrate. In other embodiments, the deformable electronic device ED can be a stretchable display device or a rollable display device (not shown). The foldable display device 100 may further include a control element 106 (such as an integrated circuit (IC)) disposed on the first surface 102a (marked in FIG. 2 and FIG. 4) of the deformable substrate 102. The control element 106 maybe electrically connected to the display layer 104 via a plurality of wirings 120 to control display related functions . A second folding axis FX2 may be included between the display layer 104 and the control element 106. The portion of the deformable substrate 102 having the control element 106 may be bent along the second folding axis FX2 backwardly to a rear surface (the second surface 102b) of the deformable substrate 102. Accordingly, the control element 106 will not occupy the front side of the foldable display device 100. The area of the foldable display device 100 may be reduced. In some embodiments, the control element 106 can be disposed on a flexible printed circuit board (not shown) and electrically connected to the wirings (not shown) on the substrate structure 102 by a chip on film (COF) technique. The flexible printed circuit board can also be bent to the second surface 102b of the deformable substrate 102. Thus, the control element 106 does not occupy the first surface 102a of the deformable substrate 102, and the area of the peripheral region may be reduced.

Referring to FIG. 1, the electronic device ED may further include other components, for example, a processing unit 108 and a control module 112. The processing unit 108 may be electrically connected to the control element 106, so as to provide operation signals. The control module 112 may include an actuator power 114, a gyroscope 116, a power management 118, and a memory unit 117. The actuator power 114 may provide power to actuate or deform the electronic device ED or the foldable display device 100, such as changing the folding angle θ of the foldable display device 100, but not limited there to. The gyroscope 116 may detect the operation condition or deformation state of the electronic device ED or the foldable display device 100. The power management 118 may manage the power consumption of the electronic device ED or the foldable display device 100. The memory unit 117 may store deformation information or folding information, such as predetermined deformation data and predetermined angles, which will be described below. Any other suitable external or internal elements or units may be included in the electronic device ED or the foldable display device 100 of the present disclosure.

Referring to FIG. 2, the foldable display device 100 can be folded with various folding angles. The portion of the deformable substrate 102 having the control element 106 may be omitted in FIG. 2, so as other following figures. The folding angle θ may range from 0° to 360°. In this embodiment, the deformable substrate 102 is a flexible substrate. When the folding angle θ is 0°, the foldable display device 100 is totally folded, a portion of the first surface 102a of the flexible substrate 102 corresponding to the first display portion P1 faces a portion of the first surface 102a corresponding to the second display portion P2, and a portion of the second surface 102b corresponding to the first display portion P1 and a portion of the second surface 102b corresponding to the second display portion P2 are at two opposite sides. When the folding angle θ is 90°, the portion of the flexible substrate 102 corresponding to the first display portion P1 is substantially perpendicular to the portion of the flexible substrate 102 corresponding to the second display portion P2. That is, the first display portion P1 is substantially perpendicular to the second display portion P2. When the folding angle θ is 180°, the flexible substrate 102 is shown as a flat plate. The folding angle θ may be 360°, such that the display layer 104 are disposed at the outer side of the foldable display device 100 and the flexible substrate 102 is sandwiched between the display layer 104.

Referring to FIG. 3 and FIG. 4, a portion of the foldable display portion PF of the foldable display device 100 is shown. The flexible substrate 102 may include a substrate film 1021 and a supporting film 1022, and the substrate film 1021 can be adhered to the supporting film 1022 through a glue layer 1023. The display layer 104 is disposed on the deformable substrate 102 and may include a plurality of switch elements and a plurality of light emitting elements LE. For example, in this embodiment, the switch elements may include thin film transistors TFT electrically connected to corresponding light emitting elements LE, and the light emitting elements LE may be one kinds of organic light emitting diodes (OLED), micro light-emitting diode (micro-LED), mini-LED, and quantum dot LED (QLED), but not limited thereto. Any suitable light emitting elements may be adopted in the display layer 104.

The deformable electronic device ED can include a bending sensor unit configured to sense a deformation value of the deformable electronic device ED. In some embodiments, the bending sensor unit can be disposed on the flexible substrate 102, for example, disposed on the display layer 104. In some embodiments, the bending sensor unit can be integrated in the display layer, that is, can be manufactured by the same procedures forming the conductive layer in the display layer.

For example, FIG. 3 and FIG. 4 show a bending sensor unit of resistance-type, and the bending sensor unit can be disposed on the display layer 104 in this embodiment. In some embodiments, the bending sensor unit can be disposed on the foldable display portion PF of the display layer 104. The bending sensor unit can include a plurality of bending sensors BS, and FIG. 3 and FIG. 4 show two bending sensors BS. In detail, the foldable display device 100 may include a bending sensor layer 130 disposed on the display layer 104, and the bending sensor layer 130 may include a conductive layer 131 and an insulating layer 132 covering the conductive layer 131. In this embodiment, the conductive layer 131 forms the bending sensors BS. Each bending sensor BS may show as a conductive line. Furthermore, each bending sensor BS may include one or more openings OP in the conductive line, which may release stress when the foldable display device 100 is folded, so as to reduce crack probability. The conductive layer 131 may include metal material(s) and/or metal oxide material(s), but not limited thereto. Examples of the metal material may include Mg, Ca, Al, Ag, W, Cu, Ni, Cr, or an alloy of one or more of the above-mentioned material . Examples of the metal oxide material may include indium tin oxide (ITO), indium zinc oxide (IZO), zinc oxide, or indium oxide. In some embodiments, the conductive layer 131 may include nanosilver wires. In addition, the conductive layer 131 can be a single layer or multiple layers. For example, the conductive layer 131 can be Mo/Al/Mo multiple layers or Ti/Cu/Ti multiple layers.

FIG. 5 and FIG. 6 show a bending sensor unit of capacitive-type, and the bending sensor unit can be disposed on the display layer 104. In some embodiments, the bending sensor unit can be disposed on the foldable display portion PF of the display layer 104. The bending sensor unit can include a plurality of bending sensors BS. Referring to FIG. 5 and FIG. 6, FIG. 5 is a partial enlargement of a top-view of an electronic device according to a variant embodiment of the first embodiment of the present disclosure, and FIG. 6 is a sectional schematic diagram of the electronic device shown in FIG. 5 along line B-B′. The bending sensor is composed of two conductive layers: the first conductive layer 1301 and the second conductive layer 1302. The first conductive layer 1301 and the second conductive layer 1302 are separated by the insulating layer 132, and a further protecting layer 140 may be formed on the second conductive layer 1302. In this variant embodiment, the first conductive layer 1301 may include a plurality of first conductive lines CL1 extending along the first direction D1, the second conductive layer 1302 may include a plurality of second conductive lines CL2 extending along the second direction D2, and one bending sensor BS is defined by an overlapping portion of one first conductive line CL1 and one second conductive line CL2, together with the insulating layer 132 corresponding to the overlapping portion.

In some embodiments, the bending sensor may be not disposed on the flexible substrate 102. Referring back to FIG. 1, the control module 112 can optionally include a deformation sensor unit 119, such as a bending sensor unit, which is not disposed on the flexible substrate 102, but disposed outside from the flexible substrate 102. For example, the bending sensor unit can be of optical type or image recognition type.

Referring to FIG. 7 and FIG. 8, the method of controlling the foldable display device 100 or the electronic device ED of the first embodiment of the present disclosure may include the following steps.

Step S100: Provide a first predetermined deformation datum Dp1. In this embodiment, the first predetermined deformation datum Dp1 may be a first predetermined angle θp1. The first predetermined deformation datum Dp1 or the first predetermined angle θp1 may be set or input by the user or the manufacturer, but not limited there to. For example, the first predetermined deformation datum Dp1 or the first predetermined angle θp1 can be stored in the memory unit 117. The first predetermined angle θp1 may be in a range from 30° to 90° according to this embodiment, but not limited thereto. In some embodiments, the first predetermined angle θp1 may be in a range from 10° to 90°. For example, the first predetermined angle θp1 may be 30°.

Step S102: Sense a deformation value DV. In this embodiment, the deformation value DV may be the folding angle θ. The folding angle θ may be sensed or detected by the bending sensors BS or the deformation sensor unit 119, as mentioned above.

Step S104: Compare the deformation value DV with the first predetermined deformation datum Dp1. For example, Step S104 may include comparing the folding angle θ with the first predetermined angle θp1 in this embodiment . For example, comparison can be performed by the processing unit 108.

Step S106: Provide a first operating status of the electronic device ED or the foldable display device 100 when the deformation value is less than the first predetermined deformation datum. The operating status can be a display status when the deformable electronic device has display function. For example, as shown in FIG. 8, the first operating status can be a first display status I. Therefore, Step S106 may include providing a first display status I when the deformation value DV (such as the folding angle θ) is less than the first predetermined deformation datum Dp1 (such as the first predetermined angle θp1). For example, when the sensed folding angle θ is 15° or 0°, and the first display status I may be a standby status or a turn-off status of the foldable display device 100, and the image displayed on the foldable display device 100 in the first display status I can have a gray level less than 50 or near 0. Alternatively, the operating status described in the present disclosure can be a display irrelevant status when the deformable electronic device has no display function. The 50 gray levels mentioned above are taken as an example when the overall gray level of the display device 100 is 255 gray levels. If the display device has different overall gray level, the gray level of the images displayed by the foldable display device 100 under the first display status I may be less than 20% (e.g., 50 gray levels/255 gray levels) of the overall gray level or almost zero gray level (e.g., 0 gray level/255 gray levels).

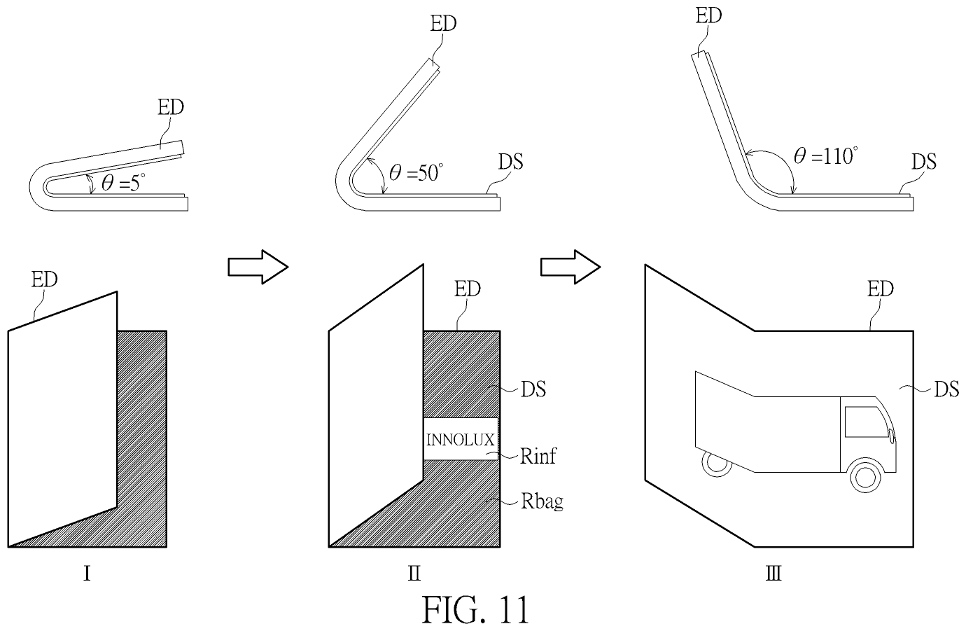

Step S108: Provide a second operating status display status of the electronic device ED or the foldable display device 100 when the deformation value is equal to or greater than the first predetermined deformation datum. The operating status can be a display status when the deformable electronic device has display function. For example, as shown in FIG. 8, the second operating status can be a second display status II. Therefore, Step S108 may include providing a second display status II when the deformation value DV (such as the folding angle θ) is greater than or equal to the first predetermined deformation datum Dp1 (such as the first predetermined angle θp1). For example, when the sensed folding angle θ is 100° or 180°, the second display status II may be a turn-on status of the foldable display device 100. In this embodiment, the display surface DS of the foldable display device 100 may face upward. The image displayed on the foldable display device 100 in the second display status II can have a gray level greater than 50 and less than 150. The aforementioned values of gray level is exemplified in the case that the overall gray level of the display device 100 is 255 gray. If the display device 100 has different number of overall gray level, the gray level of the image displayed by the foldable display device 100 can be greater than 20% of the overall gray level (e.g., 50 gray levels/255 gray levels) and less than 60% of the overall gray level (e.g., 150 gray levels/255 gray levels) under the second display status II. The foldable display device 100 has a first average luminance in the first display status I and a second average luminance in the second display status II, and the second average luminance is higher than the first average luminance. When the foldable display device 100 is operated in the second display status II, the first display portion P1, the foldable display portion PF, and the second display portion P2 may together display a continuous image. In a variant embodiment, the second display status II may be a start-up status that displays preliminary information. For example, the second display status II may include an information region Rinf and a background region Rbag, as shown in the display status II in FIG. 11. The background region Rbag can be darker than the information region Rinf and can have a greater area than the information region Rinf. The information region Rinf may display text, letters, or logos for instance. FIG. 8 shows another state of the second display status II′ when the folding angle θ is 180°.

In variant embodiments, referring to FIG. 7, Step S402 can be optionally performed before Step S102 as following.

Step 402: Trigger the bending sensor unit. For example, when the electronic device ED or foldable display device 100 receives an operation signal, the bending sensor unit is triggered. In some embodiments, the foldable display device 100 can receive a triggering signal by the bending sensors of the bending sensor unit and then perform Step S102 (sensing the deformation value DV or folding angle).

The foldable display device and electronic device of the present disclosure is not limited to the above mentioned embodiment. Further embodiments or variant embodiments of the present disclosure are described below. It should be noted that the technical features in different embodiments described can be replaced, recombined, or mixed with one another to constitute another embodiment without departing from the spirit of the present disclosure. For making it easier to compare the difference between the embodiments and variant embodiments, the following description will detail the dissimilarities among different variant embodiments or embodiments and the identical features will not be redundantly described.

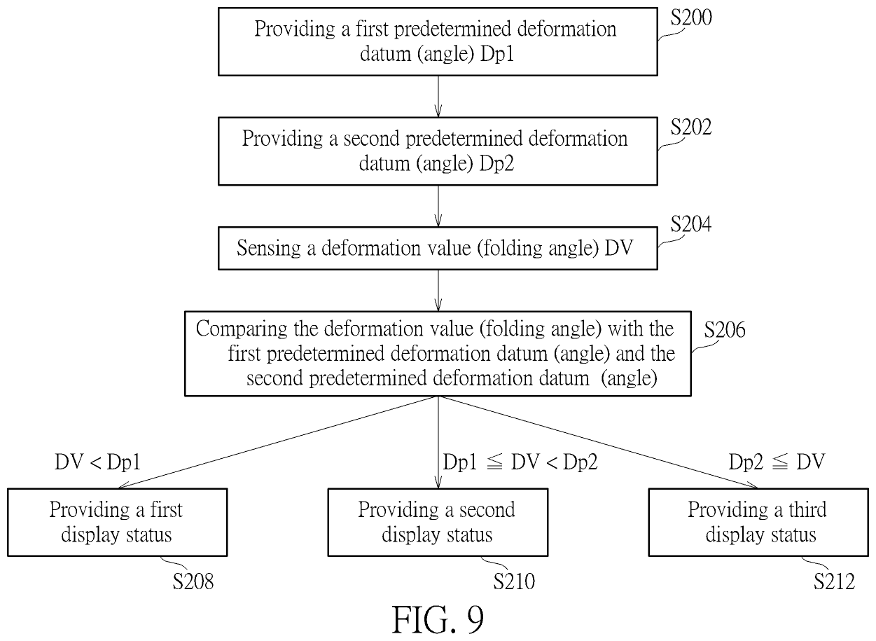

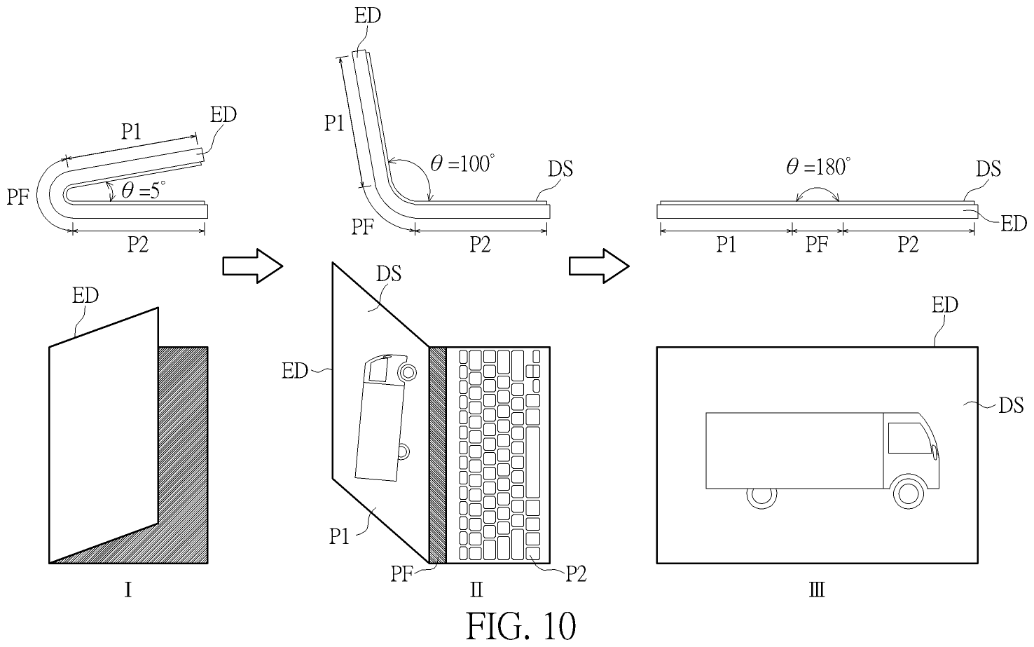

Referring to FIG. 9 and FIG. 10, FIG. 9 is a flow chart showing a method of controlling the electronic device according to a second embodiment of the present disclosure, and FIG. 10 is a schematic diagram illustrating the appearance of the electronic device in different display statuses. The method of controlling the foldable display device 100 or the electronic device ED of the second embodiment of the present disclosure may include the following steps.

Step S200: Provide a first predetermined deformation datum Dp1. In this embodiment, the first predetermined deformation datum Dp1 maybe a first predetermined angle θp1. The first predetermined angle θp1 may be in a range from 30° to 90° according to this embodiment. For example, the first predetermined angle θp1 may be 30°, but not limited thereto.

Step S202: Provide a second predetermined deformation datum Dp2. In this embodiment, the second predetermined deformation datum Dp2 maybe a second predetermined angle θp2. The second predetermined angle θp2 maybe in a range from 30° to 180° according to this embodiment. For example, the second predetermined angle θp2 may be 90°, but not limited thereto. The value of the second predetermined deformation datum Dp2 may be greater than the value of the first predetermined deformation datum Dp1, but not limited thereto.

Step S204: Sense a deformation value DV. In this embodiment, the deformation value DV may be the folding angle θ.

Step S206: Compare the deformation value DV with the first predetermined deformation datum Dp1 and the second predetermined datum Dp2. For example, Step S206 may include comparing the folding angle θ with the first predetermined angle θp1 and the second predetermined angle θp2 in this embodiment.

Step S208: Provide a first display status I (shown in FIG. 10) of the electronic device ED or the foldable display device 100 when the deformation value DV (such as the folding angle θ) is less than the first predetermined deformation datum Dp1 (such as the first predetermined angle θp1). For example, the folding angle θ is 5°, and the first display status I may be a standby status or a turn-off status. Similar to the above embodiment, an operating status, which may not be a display status, can also be provided according to comparison result of the deformation value with the predetermined deformation datum, and detailed descriptions are omitted.

Step S210: Provide a second display status II of the electronic device ED or the foldable display device 100 when the deformation value DV (such as the folding angle θ) is greater than or equal to the first predetermined deformation datum Dp1 (such as the first predetermined angle θp1) but less than the second predetermined datum Dp2 (such as the second predetermined angle θp2). For example, the sensed folding angle θ is 100°, and the second display status II may be a turn-on status of the foldable display device 100, and the image displayed on the foldable display device 100 in the second display status II can have a gray level greater than 50. When the foldable display device 100 is operated in the second display status II, the first display portion P1 and the second display portion P2 may individually display independent images. For example, the first display portion P1 may display an image that can provide information to the user, the second display portion P2 may display a keyboard picture such that the user can operate the second display portion P2 as a physical keyboard, and the foldable display portion PF may show dark image or be in a turn-off status.

Step S212: Provide a third display status III of the electronic device ED or the foldable display device 100 when the deformation value DV (such as the folding angle θ) is greater than or equal to the second deformation datum Dp2 (such as the second predetermined angle θp2). For example, the sensed folding angle θ is 180°, and the first display portion P1, the foldable display portion PF, and the second display portion P2 may together display a continuous image.

Referring to FIG. 11, FIG. 11 is a schematic diagram illustrating the appearance of the electronic device according to a variant embodiment of the second embodiment of the present disclosure. This variant embodiment is different from the second embodiment mainly in that the second display status is different. For example, the second display status II may be a start-up status and may include an information region Rinf and a background region Rbag. The background region Rbag is darker than the information region Rinf and has a greater area than the information region Rinf. The information region Rinf may display text, letters, or logos for instance. In addition, the second display status II may have an average luminance less than the average luminance of the third display status III. FIG. 11 shows the second display status II when the folding angle θ is 50° and the third display status III when the folding angle θ is 110°. The method of measuring the aforementioned average luminance may include dividing the section of two side lengths of the rectangular display area of the display device 100 into 10 equal parts, measuring the luminance in five data points (1,1), (9,1), (5,5), (1,9), (9,9) respectively, and then calculating the average luminance. The unit area of each data point measured by camera charge-coupled device (CCD) can be, for example, 2 mm*2 mm, 1 mm*1 mm or other suitable size. If the display area is not rectangular, the maximum inner rectangle that can be found in the display area is taken as the calculation benchmark.

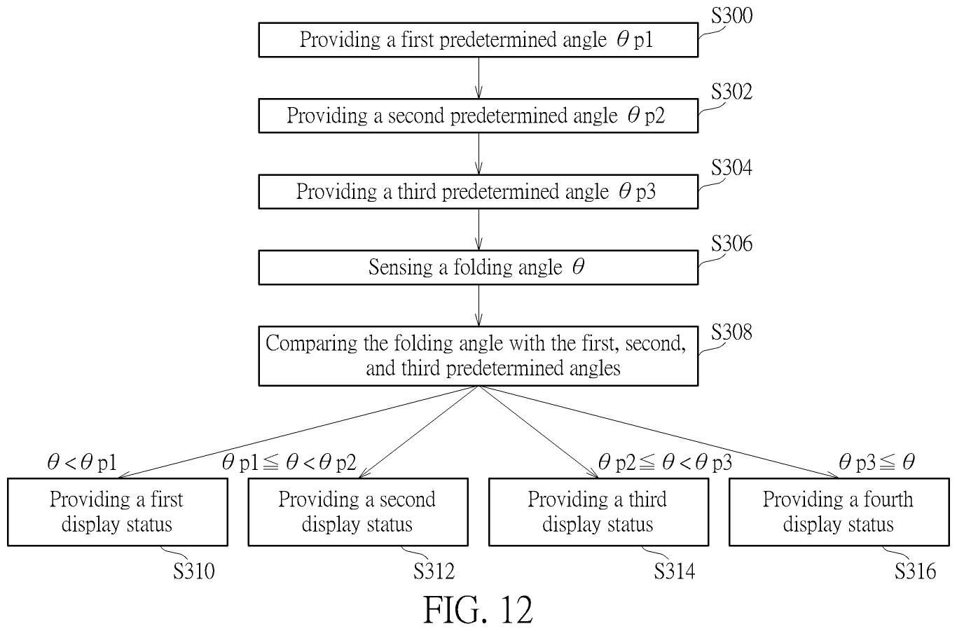

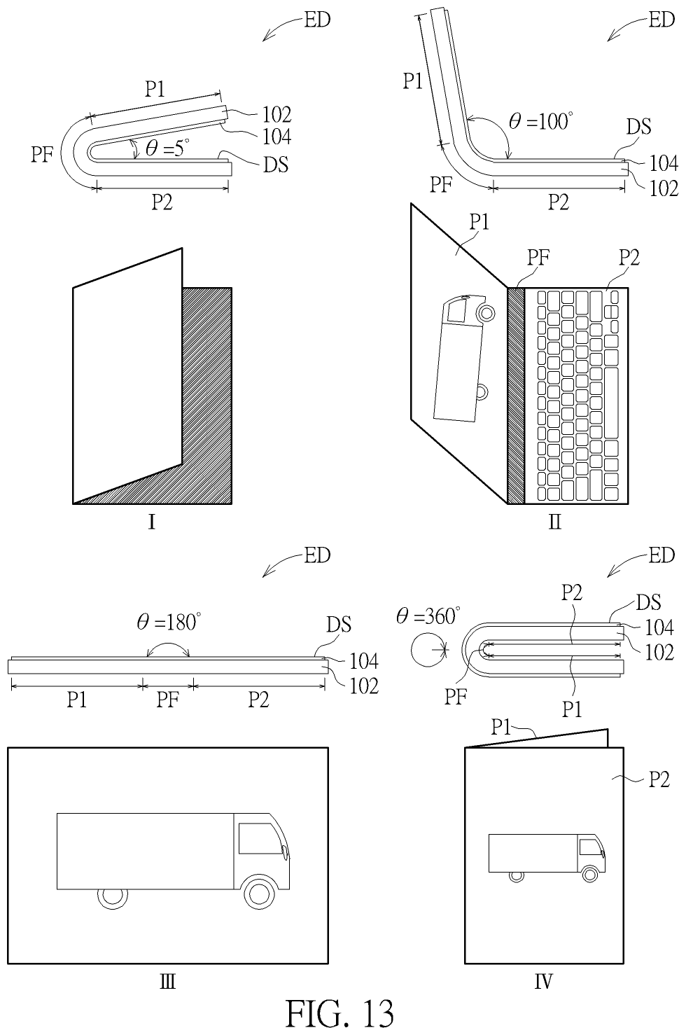

Referring to FIG. 12 to FIG. 13, FIG. 12 is a flowchart showing a method of controlling the electronic device according to a third embodiment of the present disclosure, FIG. 13 is a schematic diagram illustrating the appearance of the electronic device in different display statuses. The method of controlling the foldable display device 100 or the electronic device ED of the second embodiment of the present disclosure may include the following steps. In this embodiment and the fourth embodiment to the sixth embodiment introduced, the predetermined angles and folding angle are used for representing the predetermined deformation data and deformation value respectively, which may be replaced by other deformation data or values, as the previous embodiments.

Step S300: Provide a first predetermined angle θp1. The first predetermined angle θp1 may be in a range from 30° to 90° according to this embodiment, but not limited thereto. For example, the first predetermined angle θp1 may be 45°.

Step S302: Provide a second predetermined angle θp2. The second predetermined angle θp2 may be in a range from 80° to 170° according to this embodiment, but not limited thereto. For example, the second predetermined angle θp2 may be 110°. The second predetermined angle θp2 is greater than the first predetermined angle θp1 in this embodiment.

Step S304: Provide a third predetermined angle θp3. The third predetermined angle θp3 maybe in a range from 150° to 200° according to this embodiment, but not limited thereto. For example, the third predetermined angle θp3 may be 180°. The third predetermined angle θp3 is greater than the second predetermined angle θp2 in this embodiment.

Step S306: Sense a folding angle θ. The folding angle θ may be sensed by the bending sensors BS for example.

Step S308: Compare the folding angle θ with the first predetermined angle θp1, the second predetermined angle θp2, and the third predetermined angle θp3 in this embodiment.

Step S310: Provide a first display status I of the electronic device ED or the foldable display device 100 when the folding angle θ is less than the first predetermined angle θp1. For example, the folding angle θ is 5°, and the first display status I may be a standby status or a turn-off status.

Step S312: Provide a second display status II of the electronic device ED or the foldable display device 100 when the folding angle θ is greater than or equal to the first predetermined angle θp1 but less than the second predetermined angle θp2. For example, the folding angle θ is 100° and the second display status II may be a turn-on status of the foldable display device 100. When the foldable display device 100 is operated in the second display status II, the first display portion P1 and the second display portion P2 may individually display independent images, which may be similar to the second display status II mentioned in the second embodiment, and detail description will not be repeated.

Step S314: Provide a third display status III of the electronic device ED or the foldable display device 100 when the folding angle θ is greater than or equal to the second predetermined angle θp2 but less than the third predetermined angle θp3. The third display status III may be similar to the third display status III mentioned in the second embodiment, and detail description will not be repeated.

Step S316: Provide a fourth display status IV of the electronic device ED or the foldable display device 100 when the folding angle θ is greater than or equal to the third predetermined angle θp3. For example, the folding angle θ is 360°. In the fourth display status IV, the first display portion P1 and the second display portion P2 may individually display independent images. In some embodiments, the first display portion P1 and a portion of the foldable display portion PF may display a continuous image together, and the second display portion P2 and another portion of the foldable display portion PF may display another continuous image together. In some embodiments, the electronic device ED may be designed to display images by only one of the first display portion P1 or the second display portion P2 in the fourth display status IV, while the other display portion is turned off. For example, the gyroscope 116 shown in FIG. 1 may be adopted to detect which display portion faces upward and that display portion may be the one which turns on. In the figure shown in FIG. 13, the second display portion P2 may be designed to display images while the foldable display portion PF and the first display portion P1 may be turned off in the fourth display status IV for instance.

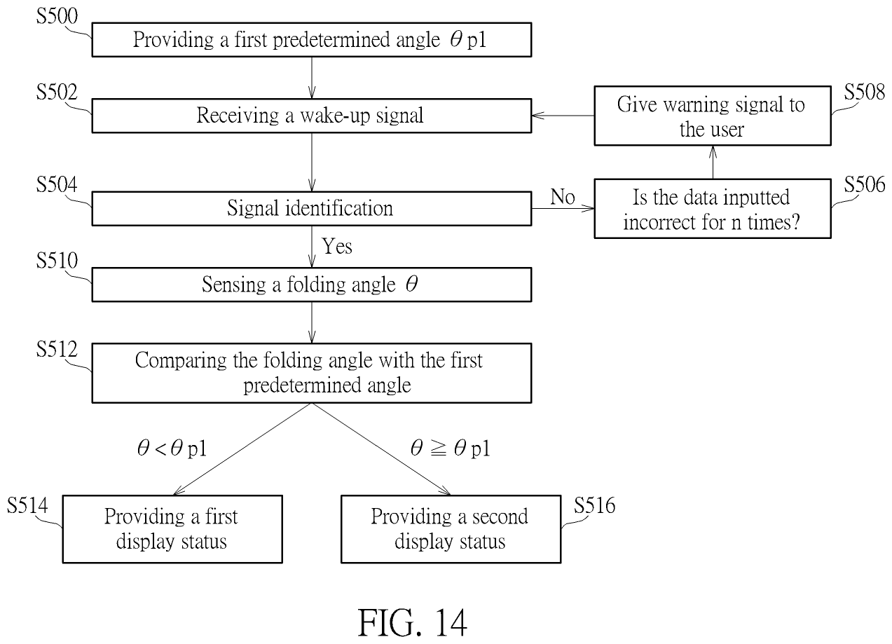

Referring to FIG. 14, FIG. 14 is a flow chart showing a method of controlling the electronic device according to a fourth embodiment of the present disclosure. The method of this embodiment may include the following steps.

Step S500: Provide a first predetermined angle θp1. The first predetermined angle θp1 may be input or set by the user or the manufacturer.

Step S502: Receive a wake-up signal. For example, the wake-up signal may be induced from a touch input or a voice input, but not limited thereto.

Step S504: Perform signal identification to identify the wake-up signal, and the received wake-up signal may be considered as a user identification signal. If the received wake-up signal passes the identification, then perform Step S510. If the received wake-up signal does not pass the identification, then perform Step S506.

Step S506: Check the item “Is the data inputted incorrect for “n” times?” If the answer is true, then perform Step S508. The above mentioned value “n” may be inputted or set by the user or the manufacturer.

Step S508: Give a warning signal to the user when the answer of Step S506 is “true”.

Step S510: Sensing a folding angle θ.

Step S512: Compare the folding angle θ with the first predetermined angle θp1.

Step 514: Provide a first display status of the electronic device when the folding angle θ is less than the first predetermined angle θp1.

Step S516: Provide a second display status of the electronic device when the folding angle θ is greater than or equal to the first predetermined angle θp1.

This embodiment is different from the first embodiment mainly in that a step of “receiving a wake-up signal” and a step of “signal identification” are incorporated in the method of controlling the electronic device (or the foldable display device). The user may input a wake-up signal when he starts to use the electronic device, and the electronic device will start up to the following Steps S510 to S516 when the wake-up signal passes the signal identification. In other words, a user identification signal is received before determining the folding angle of the electronic device.

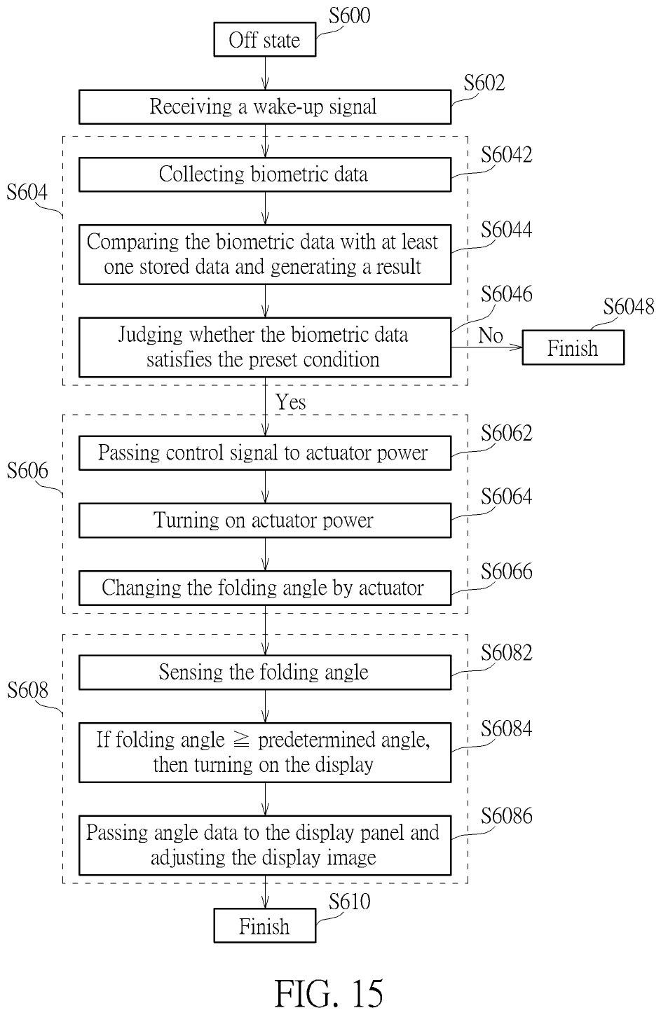

Referring to FIG. 15, FIG. 15 is a flow chart showing a method of controlling the foldable display device (or electronic device) according to a fifth embodiment of the present disclosure. The method of controlling the foldable display device (or the electronic device) of this embodiment may include the following steps.

Step S600: The foldable display device is in an off state.

Step S602: Receive a wake-up signal.

Step S604: Perform a signal identification, which includes Steps S6042 to S6048.

Step S6042: Collect biometric data of the wake-up signal, such as voice data, fingerprint data, iris data, and so on.

Step S6044: Compare the biometric data with at least one stored data and generate a result.

Step S6046: Judge whether the biometric data satisfies the preset condition. If the judging result is “yes”, then perform Step S606. If the judging result is “no”, then perform Step S6048.

Step S6048: Finish the operation of the foldable display device.

Step S606: Start up the foldable display device. Step S606 includes the Step S6062 to Step S6066.

Step S6062: Pass control signal to an actuator power.

Step S6064: Turn on the actuator power (power on).

Step S6066: Change the folding angle by the actuator.

Step S608: Determine the display status. Step S608 includes Steps S6082 to S6086.

Step S6082: Sense the folding angle. For example, the folding angle may be sensed by the bending sensor.

Step S6084: If the folding angle is greater than or equal to a predetermined angle, then turn on the foldable display device. The predetermined angle can be inputted by the user or the manufacture before usual operation of the foldable display panel.

Step S6086: Pass the angle data to the foldable display device and adjust the display image.

Step S610: Finish.

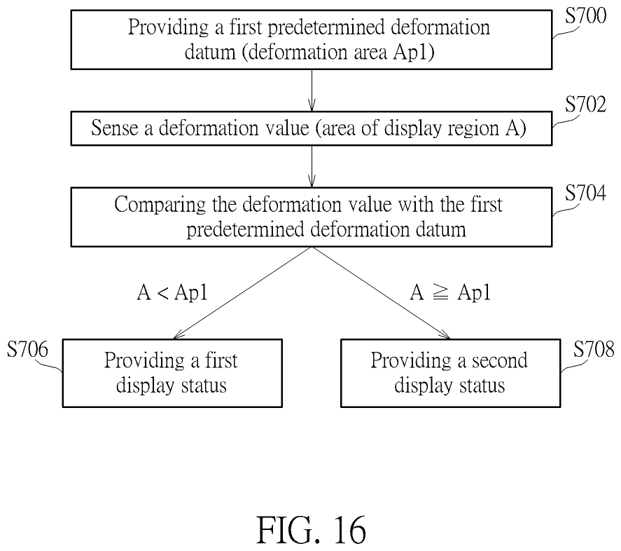

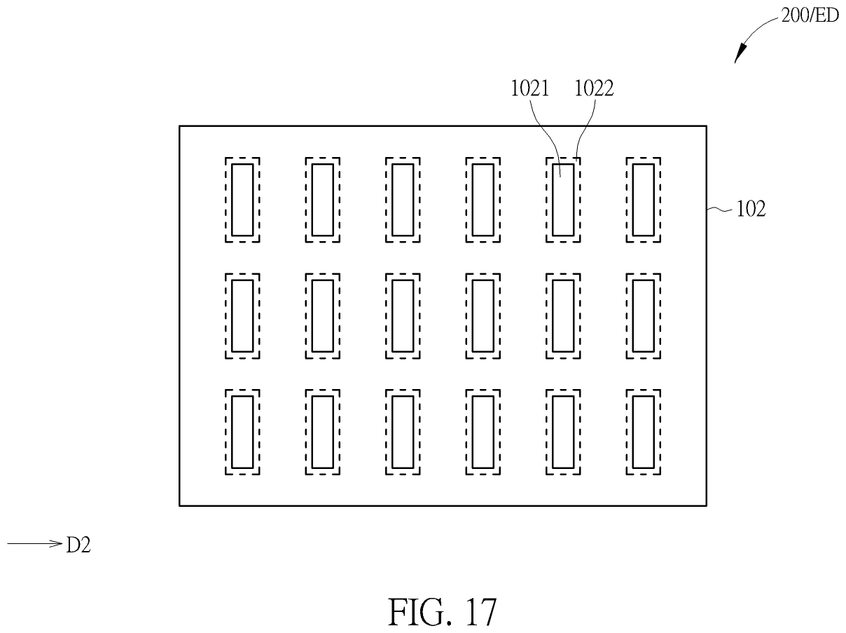

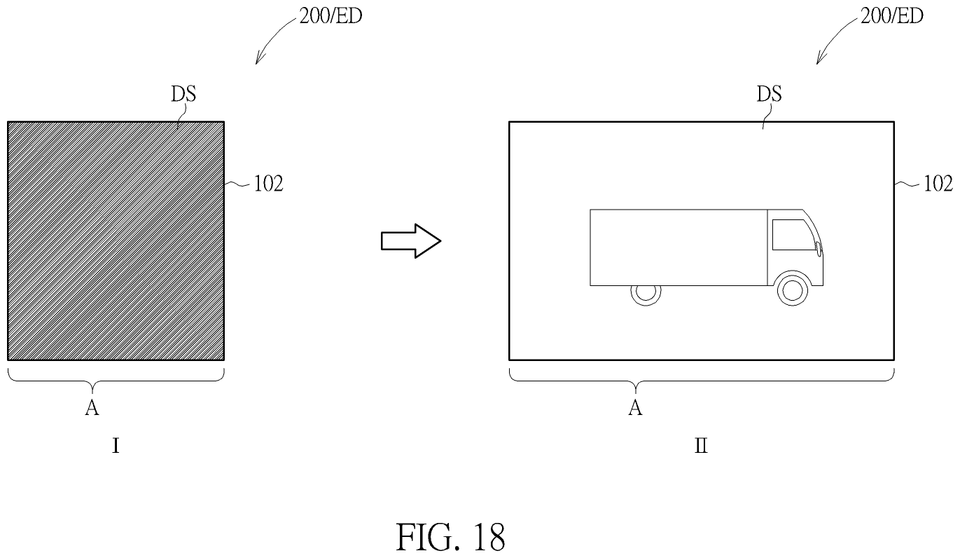

Referring to FIG. 16 to FIG. 18, FIG. 16 is a method of controlling the electronic device according to a sixth embodiment of the present disclosure, FIG. 17 is a schematic top-view of the deformable substrate of the electronic device of the sixth embodiment of the present disclosure, and FIG. 18 is a schematic diagram illustrating the appearances of the electronic device in different display statuses of the six embodiment of the present disclosure. The electronic device ED of this embodiment includes a stretchable display device 200, and the stretchable display device 200 includes a deformable substrate 102 and a display layer disposed on the deformable substrate 102. The deformable substrate 102 can have a plurality of stretchable openings 1021 and may be stretchable. The shapes of the openings 1021 are not limited to FIG. 17. The openings 1021 may individually have any suitable shapes, such as rectangular shapes, ellipse shapes, round shapes, and so on. By means of stretchable function, the display region of the deformable display device 200 can be varied by stretching. For example, the exposed display region (as marked by the symbol “A”) can be increased when the force is applied along the direction D2. In addition, a plurality of deformation sensors 1022 may be disposed in the display layer. For example, the deformation sensors 1022 can be disposed corresponding to the position of the openings, such as around or adjacent to the openings 1021. The deformation sensors 1022 can detect the deformation degree of the corresponding openings 1021. Based on the individual detecting results or the integrated detecting results of the deformation sensors 1022, the processing unit 108 of the deformable electronic device ED can process the detecting results and obtain the dimension (such as width or length) of the exposed display region A, or obtain the area of the exposed display region A of the electronic device ED.

The method of controlling the electronic device of this embodiment may include the following steps.

Step S700: Provide a first predetermined deformation datum. For example, the first predetermined deformation datum can be a dimension or area. In this embodiment, the first predetermined deformation datum may refer to the first predetermined deformation area Ap1.

Step S702: Sense a deformation value of the electronic device ED. In some embodiments, the deformation value can be a dimension or area of the exposed display region A of the stretchable display device 200. For example, the area of the exposed display region A can be sensed by the deformation sensors 1022 and obtained by the processing unit 108.

Step S704: Compare the deformation value with the first predetermined deformation area Ap1. For example, compare the area of the exposed display region A with the first predetermined deformation area Ap1.

Step S706: If the deformation value (the area of the exposed display region A) is smaller than the first predetermined deformation datum (first predetermined deformation area Ap1), then provide a first display status I of the electronic device ED. For example, the first display status I may be a turn-off status or dark status.

Step S708: If the deformation value (the area of the exposed display region A) is greater than or equal to the first predetermined deformation datum (the first predetermined deformation area Ap1), then provide a second display status II of the electronic device ED. For example, the second display status II is a turn-on status, and the electronic device ED may display a continuous image in the whole display region A when it is stretched up to have a big enough display region.

In a variant embodiment, the deformation sensors 1022 may be disposed on one or more edges of the deformable substrate 102 of the electronic device ED, such that the deformation sensors 1022 can sense the total length and/or width of the deformable substrate 102, so as to obtain the area of the display region A.

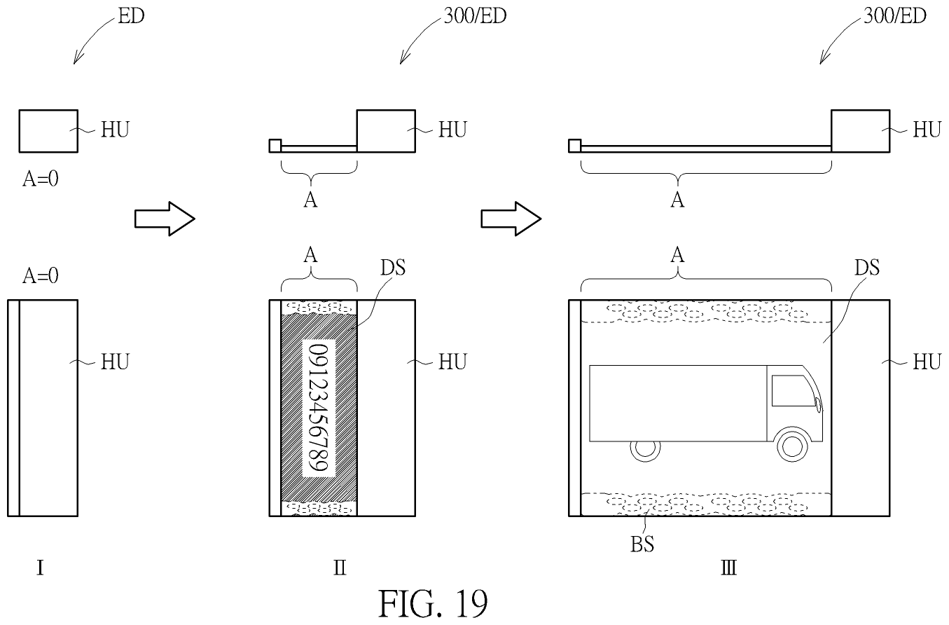

Referring to FIG. 19, FIG. 19 is a schematic diagram illustrating the appearances of an electronic device in different display statuses according to a seventh embodiment of the present disclosure. The electronic device ED includes a rollable display device 300 and may further include a housing HU. The rollable display device 300 maybe contained in the housing HU when it is not in operation. By means of rollable function, the exposed display region A of the rollable display device 300 can be varied by rolling.

The method of controlling the electronic device ED may refer to the flow chart shown in FIG. 9 and the flow chart shown in FIG. 16. A first predetermined deformation datum Dp1 and a second predetermined deformation datum Dp2 may be provided. The first predetermined deformation datum Dp1 and the second predetermined deformation datum Dp2 may be a dimension or area, and the second predetermined datum Dp2 is greater than the first predetermined datum Dp1. When the electronic device ED is in operation, a deformation value is sensed. For example, the deformation value may be the area of the exposed display region A of this embodiment, thus the first predetermined deformation datum Dp1 may be a first predetermined deformation area Ap1 and the second predetermined deformation datum Dp2 maybe a second predetermined deformation area Ap2. If the sensed area of the exposed display region A is less than the first predetermined deformation area Ap1, a first display status I is provided to the rollable display device 300. For example, the first display status I is a turn-off status, as shown in FIG. 19. If the sensed area of the exposed display region A is greater an or equal to the first predetermined deformation area Ap1 but less than the second predetermined deformation area Ap2, a second display status II is provided to the rollable display device 300. For example, the second display status II may be a start-up status or a preliminary display status, thus the rollable display device 300 may only show preliminary information or a few texts in the exposed display region A. In some embodiments, the second display status II maybe a turn-on status. If the sensed area of the display region A is greater than or equal to the second predetermined deformation area Ap2, a third display status III is provided to the rollable display device 300. For example, a continuous image maybe displayed in the whole display region A in the third display status III. In this embodiment, one or more deformation sensors BS may be disposed on the edges of the display device 300 for sensing the display region A.

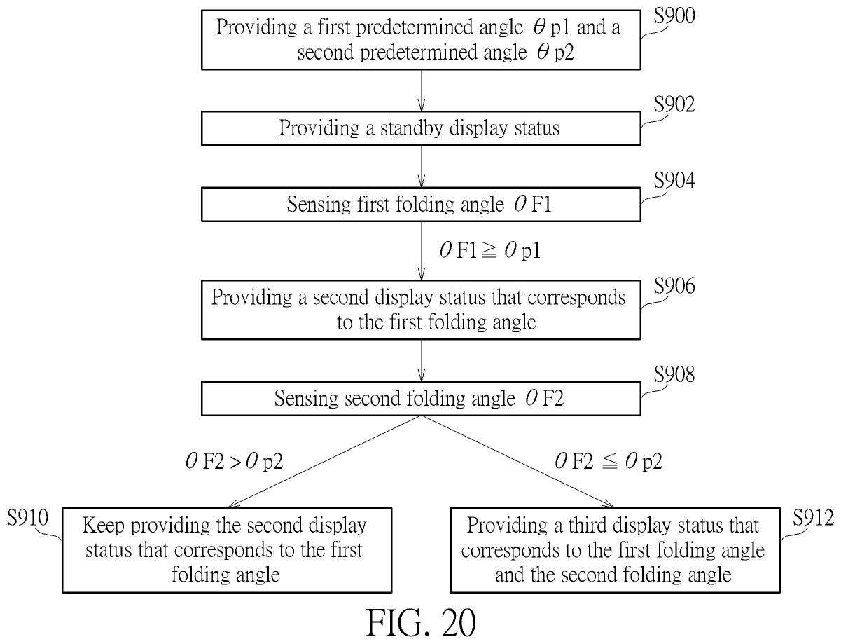

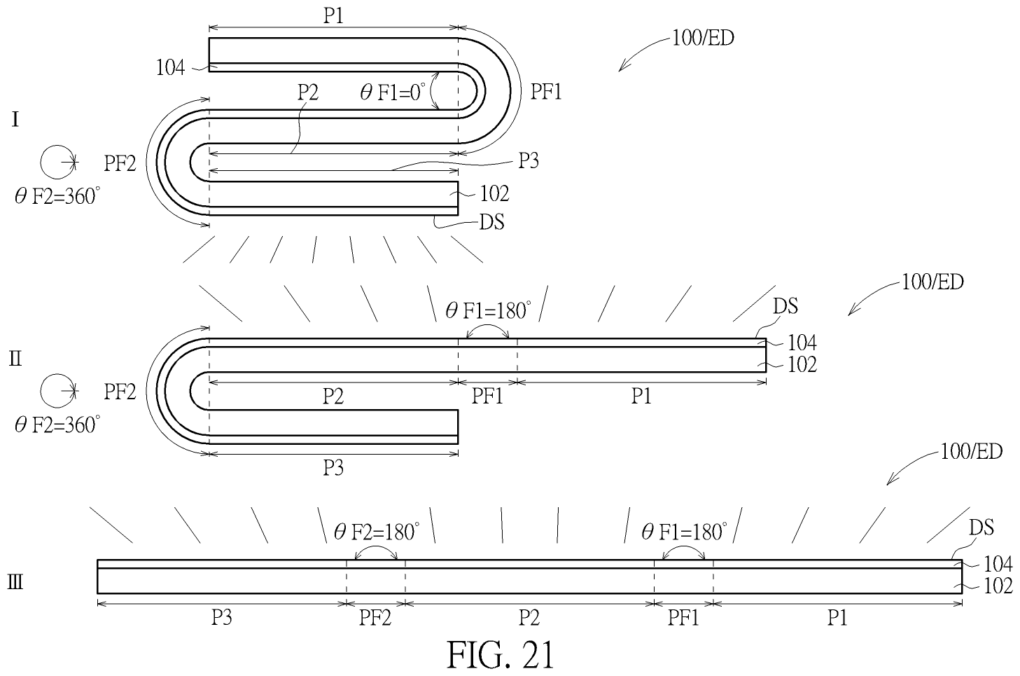

Referring to FIG. 20 to FIG. 21, FIG. 20 is a method of controlling an electronic device according to an eighth embodiment of the present disclosure and FIG. 21 is a schematic diagram illustrating the appearances of the electronic device in different display statuses of the eighth embodiment of the present disclosure. The foldable display device 100 includes two foldable display portions PF1 and PF2. A first foldable display portion PF1 is disposed between the first display portion P1 and the second display portion P2, and a second foldable display portion PF2 is disposed between the second display portion P2 and the third display portion P3. The foldable display device 100 can be folded at the first foldable display portion PF1 and the second foldable display portion PF2. The first foldable display portion PF1 has a first folding angle θF1 and the second foldable display PF2 has a second folding angle θF2. The method of controlling the electronic device ED or the foldable display device 100 may include the following steps.

Step S900: Provide a first predetermined angle θp1 corresponding to the first folding angle θF1 and a second predetermined angle θp2 corresponding to the second folding angle θF2. For example, the first predetermined angle θp1 is 45° and the second predetermined angle θp2 is 315°, but not limited thereto.

Step S902: Provide a standby display status to the foldable display device 100. For example, the standby display status is a first display status I of the foldable display device 100 as shown in FIG. 21. The standby display status may be provided when the first folding angle θF1 is less than the first predetermined angle θp1 and the second folding angle θF2 is greater than the second predetermined angle θp2 . For example, when the first folding angle θF1 is 0° and the second folding angle θF2 is 360°, the first display portion P1, the second display portion P2, and the third display portion P3 are folded to overlap each other. In the first display status I, the third display portion P3 may be turned on and display images, and the display surface DS is at the portion of the display layer 104 within the third display portion P3, while the first display portion P1, the second display portion P2, the first foldable display portion PF1, and the second foldable display portion PF2 may be turned off.

Step S904: Sense the first folding angle θF1. One or more bending sensors may be used for sensing the first folding angle θF1 for example.

Step S906: If the first folding angle θF1 is greater than or equal to the first predetermined angle θp1, then provide a second display status II that corresponds to the first folding angle θF1. For example, the first folding angle θF1 may be about 180°. In the second display status II, the first display portion P1, the second display portion P2 and the first foldable display portion PF1 are configured as a flat plate with an area greater than that of the third display portion P3, and the display surface DS is at the portion of the display layer 104 within the first display portion P1, the second display portion P2 and the first foldable display portion PF1.

Step S908: Sense the second folding angle θF2. One or more bending sensors may be used for sensing the second folding angle θF2 for example.

Step S910: If the second folding angle θF2 is greater than the second predetermined angle θp2, then keep providing the second display status II that corresponds to the first folding angle θF1.

Step S912: If the second folding angle θF2 is less than or equal to the second predetermined angle θp2, then provide a third display status III. For example, when both the first folding angle θF1 and the second folding angle θF2 may be 180°, provide a third display status III. In the third display status III, the first display portion P1, the second display portion P2, the third display portion P3, the first foldable display portion PF1, and the second foldable display portion PF2 maybe configured as a flatplate, and all of these portions may display a continuous image together.

According to the present disclosure, one or more predetermined deformation data (such as corresponding to folding angles, display areas, display range and so on) may be preset or pre-input in the electronic device (or the foldable display device), and different operating statuses (such as display statuses) of the electronic device may be provided to respond different deformation values in comparison with corresponding predetermined deformation data. The electronic device of the present disclosure can therefore provide various display functions at different deformation states.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method of controlling a foldable display device comprising a flexible substrate and a display layer disposed on the flexible substrate, the display layer comprising a first display portion, a second display portion and a foldable display portion connecting the first display portion and the second display portion, the method comprising:
providing a first predetermined angle;
sensing a folding angle between the first display portion and the second display portion;
comparing the folding angle with the first predetermined angle;
providing a first display status of the foldable display device when the folding angle is less than the first predetermined angle; and
providing a second display status of the foldable display device when the folding angle is equal to or greater than the first predetermined angle,
wherein the first display status is a turn-off status, and the second display status is a turn-on status,
wherein the flexible substrate has a plurality of openings.

2. The method of controlling the foldable display device of claim 1, wherein the first predetermined angle is less than 15 degrees.

3. The method of controlling the foldable display device of claim 1, wherein at least one of the plurality of openings has a rectangular shape, an ellipse shape or a round shape.

4. The method of controlling the foldable display device of claim 1, wherein a deformation sensor is disposed corresponding to one of the plurality of openings.

5. The method of controlling the foldable display device of claim 1, wherein the foldable display device further comprises a bending sensor unit disposed on the display layer, the bending sensor unit has a plurality of bending sensors, and the folding angle is sensed by the bending sensor unit.

6. The method of controlling the foldable display device of claim 5, wherein at least one of the plurality of bending sensors is composed of a first conductive layer and a second conductive layer which are separated from each other by an insulating layer.

7. The method of controlling the foldable display device of claim 6, wherein the first conductive layer includes a plurality of first conductive lines extending along a first direction, the second conductive layer includes a plurality of second conductive lines extending along a second direction different from the first direction, one of the plurality of bending sensors is defined by an overlapping portion of one of the plurality of first conductive lines and one of the plurality of second conductive lines together with the insulating layer corresponding to the overlapping portion.

8. The method of controlling the foldable display device of claim 7, wherein the display layer comprises a plurality of light emitting elements, and the plurality of bending sensors are not overlapped with the plurality of light emitting elements.

9. The method of controlling the foldable display device of claim 1, wherein at least one of the plurality of openings is disposed corresponding the foldable display portion.

10. A foldable display device, comprising:
a flexible substrate; and
a display layer disposed on the flexible substrate, the display layer comprising a first display portion, a second display portion and a foldable display portion connecting the first display portion and the second display portion,
wherein the flexible substrate has a plurality of openings.

11. The foldable display device of claim 10, wherein at least one of the plurality of openings has a rectangular shape, an ellipse shape or a round shape.

12. The foldable display device of claim 10, wherein a deformation sensor is disposed corresponding to one of the plurality of openings.

13. The foldable display device of claim 10, wherein the foldable display device further comprises a bending sensor unit disposed on the display layer, and the bending sensor unit has a plurality of bending sensors.

14. The foldable display device of claim 13, wherein at least one of the plurality of bending sensors is composed of a first conductive layer and a second conductive layer which are separated from each other by an insulating layer.

15. The foldable display device of claim 14, wherein the first conductive layer includes a plurality of first conductive lines extending along a first direction, the second conductive layer includes a plurality of second conductive lines extending along a second direction different from the first direction, one of the plurality of bending sensors is defined by an overlapping portion of one of the plurality of first conductive lines and one of the plurality of second conductive lines together with the insulating layer corresponding to the overlapping portion.

16. The foldable display device of claim 15, wherein the display layer comprise a plurality of light emitting elements, and the plurality of bending sensors are not overlapped with the plurality of light emitting elements.

17. A deformable electronic device, comprising:
a deformable substrate;
an electronic layer disposed on the deformable substrate;
a memory unit configured to store a first predetermined deformation datum;
a bending sensor unit configured to sense a deformation value of the deformable electronic device; and
a processing unit configured to:
compare the deformation value with the first predetermined deformation datum,
provide a first operating status of the deformable electronic device when the deformation value is less than the first predetermined deformation datum, and
provide a second operating status of the deformable electronic device when the deformation value is equal to or greater than the first predetermined deformation datum.

18. The deformable electronic device of claim 17, wherein the deformation value is a dimension or area of an exposed display region of the deformable display device.
